(19) United States
(12) Patent Application Publication
(10) Pub. No.: US 2008/0030012 A1
(43) Pub. Date: Feb. 7, 2008

(54) Passenger Protection Device

(76) Inventors: Bernhard Mattes, Sachsenheim (DE); Hans-Peter Stumpp, Markgroeningen (DE); Werner Nitschke, Ditzingen (DE); Hartmut Schumacher, Freiberg (DE); Walter Wottreng, Schwieberdingen (DE); Hans Guettler, Untergruppenbach (DE); Rainer Moritz, Filderstadt (DE); Thomas Herrmann, Oehringen (DE); Frank-Juergen Stuetzler, South Lion, MI (US); Alexander Vogt, Stuttgart (DE); Kunt Balzer, Beilstein (DE); Thomas Lich, Schwaikheim (DE); Ulrike Groeger, Hovell, MI (US); Alfred Kuttenberger, Moeglingen (DE); Lothar Groesch, Farmington Hills, MI (US); Michael Schmid, Kornwestheim (DE); Mario Kroeninger, Buehl (DE)

Correspondence Address: KENYON & KENYON LLP, ONE BROADWAY, NEW YORK, NY, 10004, US

(21) Appl. No.: 10/588,598

(22) PCT Filed: Jan. 5, 2005
(86) PCT No.: PCT/EP05/50034

§ 371 Date: May 25, 2007

(30) Foreign Application Priority Data
Feb. 26, 2004 (DE) 10 2004 009 300.8

(51) Int. Cl. B60R 21/26; B60R 21/268

(52) U.S. Cl. 280/736; 280/741

(57) ABSTRACT

A passenger protection device in a motor vehicle includes at least one airbag, at least one gas generator for filling the airbag, an airbag control device for activating the airbag, means for acquiring the deployment speed of the airbag, and means for regulating the filling quantity of the airbag, taking into account its deployment speed. In order for the passenger protection device to implement a controlled filling of the airbag dependent on its deployment speed, at least one flow-off valve is provided that is situated between the gas generator and the airbag. In addition, controllable actuating means are provided for the sealing of the flow-off valve.

### FIELD OF THE INVENTION

The present invention relates to a passenger protection device, in particular for a motor vehicle, having at least one airbag and means for regulating the filling quantity of the airbag, taking into account its deployment speed.

### BACKGROUND INFORMATION

Airbags in a motor vehicle are generally allocated to a particular seat, or to the passenger occupying that seat. The action of an activated airbag is standardly designed such that the risk of injury for the corresponding passenger in the given accident situation is minimized as long as the passenger is sitting in an upright position at the moment at which the airbag is triggered, and is held by the available safety belts, and is leaning against the back rest of the seat. Under these preconditions, the passenger will at first be situated at a certain distance from the fully inflated airbag before falling into it. However, it may also occur that at the moment of the accident the passenger is in a different position, for example leaning forward. Such “Out-of-Position”, or “OOP”, situations can result in very serious injuries to the passenger if he or she comes into contact with the deploying airbag and the filling of the airbag takes place in an uncontrolled manner. For this reason, various designs have already been developed for acquiring the deployment speed of an airbag in order to reduce the filling quantity if an “obstacle” is situated in the deployment path of the airbag.

In published international patent application WO 03/039918 A1, a passenger protection device is described that includes an airbag having a filling device for inflating the airbag. Here the deployment speed of the airbag is acquired in contactless fashion. For this purpose, a transceiver device for electromagnetic waves is provided, and what is known as an interrogation unit is provided that is situated on the airbag cover. While the airbag is deploying, the transceiver device sends electromagnetic waves to the interrogation unit, which moves with the airbag cover. The response signal sent by the interrogation unit to the transceiver device is then evaluated by an evaluation unit connected to the transceiver device.

The measures described in published international patent application WO 03/039918 may theoretically make it possible to control the filling quantity of an airbag dependent on its deployment speed. However, in practice, a correspondingly controlled filling of an airbag proves to be problematic, because the total duration of the inflation must last only about 30 ms.

### SUMMARY

The present invention provides a passenger protection device having means for a controlled filling of the airbag dependent on its deployment speed, which means are easy to implement.

For this purpose, the passenger protection device according to the present invention is equipped with at least one discharge (flow-off) valve situated between the gas generator and the airbag, as well as controllable actuating means for sealing the flow-off valve.

According to the present invention, using the controllable flow-off valve, acting in the outward direction, it is easy to divert a defined quantity of the pressure gas if an obstacle is detected in the deployment path of the airbag, or if the presence of such an obstacle is indicated by the deployment speed of the airbag. The quantity of filling for the airbag can in this way easily be controlled in a manner that takes into account the deployment speed, or the size and position of an obstacle in the deployment path.

Most passenger protection devices are equipped with a central airbag control device to which all possible information is provided concerning the state of the vehicle, the occupation of the seats, the traffic situation, etc., in order to recognize dangerous situations as reliably as possible and then to activate suitable restraint means. In this case, it often proves advantageous if the means for acquiring the deployment speed of the airbag and the actuation means for sealing the flow-off valve are also connected to the airbag control device. On the one hand, the airbag control device has means suitable for evaluating measurement data that can also be used to determine and interpret the deployment speed, while on the other hand the information available to the airbag control device, for example information about seat occupancy, can also be taken into account in the interpretation of the determined deployment speed and its regulation. Moreover, the signal propagation times between the acquisition of measurement data during the airbag deployment and the controlling of the flow-off valve can be minimized with the aid of a central airbag control device.

On the one hand, the seal of the flow-off valve must be designed such that when the flow-off valve is closed a sufficiently large throttle effect is achieved for the gas flowing out of the activated gas generator, so that the airbag is completely inflated with maximum speed. On the other hand, the flow-off valve must be dimensioned such that when the valve is open a significant quantity of gas can flow outward, so that the airbag is not completely inflated. Moreover, in order to be able to regulate the deployment speed or filling quantity of the airbag at all, it must be possible to realize a very rapid valve stroke. In this connection, it is advantageous if the actuating means for sealing the flow-off valve include a piezoactuator connected to a mechanical or hydraulic lever device. In another advantageous embodiment of the passenger protection device according to the present invention, the seal of the flow-off valve is actuated with the aid of an electromagnet.

In principle, the passenger protection device according to the present invention may be implemented with any type of gas generator, the physical and chemical properties, e.g., the flow-off speed, of the gas or gas mixture used being taken into account in the design of the discharge valve. In an example embodiment that is particularly easy to manipulate and also economical, the passenger protection device according to the present invention is equipped with a cold gas generator that is filled with a noble gas mixture under pressure and is equipped with a pyrotechnic charge for destroying the burst disk.

The use of a noble gas mixture for inflating the airbag also proves advantageous with regard to the determination of the deployment speed of the airbag. Because noble gas mixtures are very clean, light can propagate in such a medium in unhindered fashion. Optical measurement methods for determining the deployment speed therefore provide very reliable results. An advantageous example embodiment of the passenger protection device according to the present invention has for this purpose a transceiver device with which optical signals, for example in the form of pulsed infrared light, are sent into the deploying airbag. Moreover, the inside of the airbag is provided at least in some parts with a light-reflecting coating, so that the optical signals are reflected and thus sent back to the transceiver device. The deployment speed of the airbag can then be determined easily through propagation time measurement, using the Doppler effect or a triangulation method.

### BRIEF DESCRIPTION OF THE DRAWINGS

FIG. 1 shows a block diagram of a passenger protection device according to the present invention.

FIG. 2 shows a schematic representation of the passenger protection device shown in FIG. 1.

FIG. 3 shows a top view of the seal of the flow-off valve shown in FIG. 2.

FIG. 4 shows a piezoactuator used as an actuating device for the seal, shown in FIG. 3, of a flow-off valve.

### DETAILED DESCRIPTION

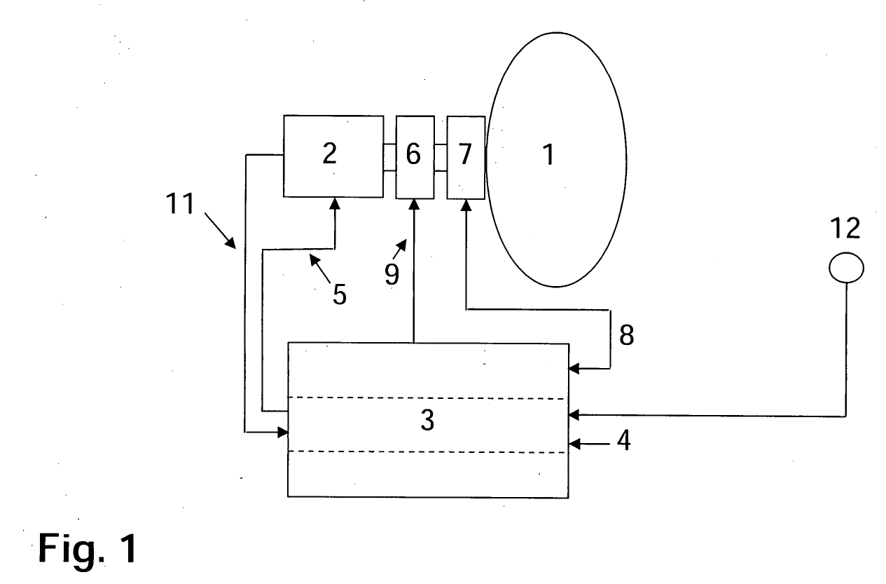

As shown in FIG. 1, a passenger protection device for a motor vehicle includes an airbag 1 which is filled with the aid of a gas generator 2 as the need arises. Gas generator 2 is connected to a central airbag control device 3, to which all available data are supplied concerning the state of the vehicle, the driving and traffic situation, seat occupancy, etc., as indicated by arrow 4. By evaluating this information, airbag control device 3 can recognize dangerous situations ahead of time, and also classify the severity of the crash and the type of the crash in order to initiate suitable preventive measures. Thus, in dangerous situations, airbag control device 3 can activate gas generator 2 via a signal line 5 in order to trigger airbag 1.

In order to ensure the functional capability of gas generator 2, in the exemplary embodiment shown here the gas pressure in gas generator 2 is continuously monitored. For this purpose, the corresponding data are transmitted to airbag control device 3 via a signal line 11. In addition, airbag control device 3 is connected to the microphone 12 of a hands-free communication device installed in the motor vehicle, which in the case of an accident is activated together with a crash recorder. In this way, the sequence of events in the accident, as well as the triggering of the restraint means, can be documented in the form of acoustic signals.

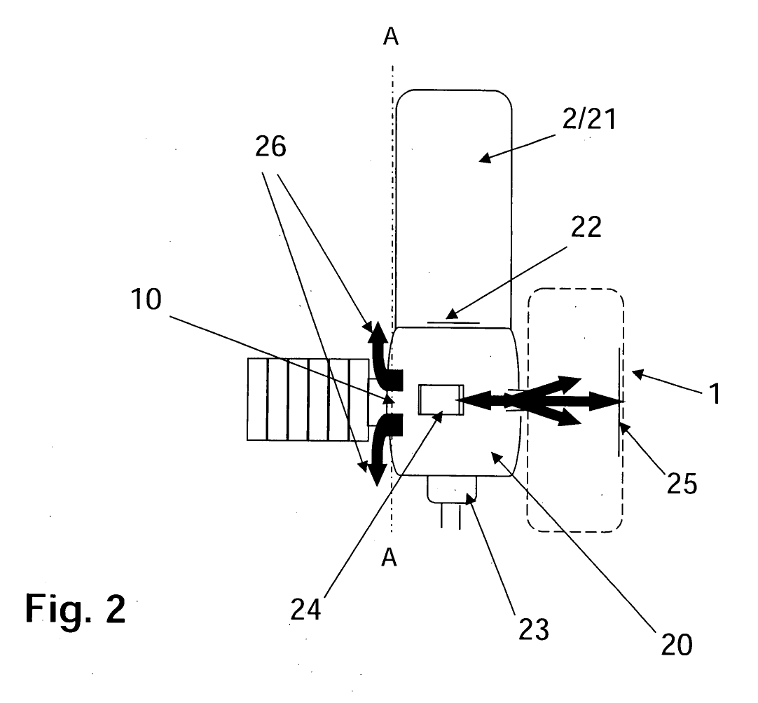

Gas generator 2 is connected to airbag 1 via a connecting module 6 and a measurement module 7. Measurement module 7 is used to acquire the deployment speed of airbag 1, and is explained in more detail in connection with FIG. 2. The evaluation of the measurement values can take place in measurement module 7 and/or in airbag control device 3, which is connected to measurement module 7 via a bidirectional line 8.

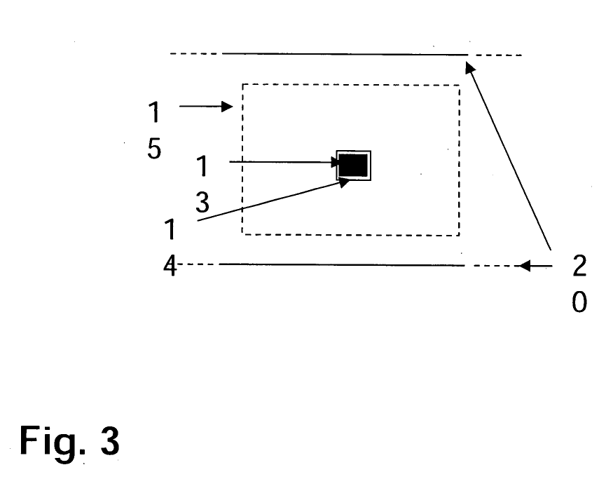

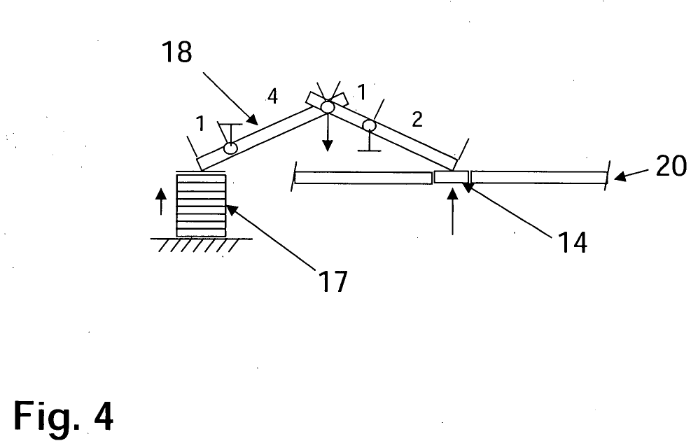

The filling quantity of airbag 1 can be controlled with the aid of connecting module 6, which has for this purpose at least one flow-off valve 10, shown in FIG. 2. The seal of the flow-off valve can be controlled by airbag control device 3 via a signal line 9. In the exemplary embodiment shown here in FIG. 1, airbag control device 3 takes over the controlling of the filling quantity, taking into account the deployment speed of airbag 1, which has been determined with the aid of measurement module 7. The actuating means for the seal of flow-off valve 10 are explained in more detail in connection with FIGS. 3 and 4.

The implementation of flow-off valve 10 between gas generator 2 and airbag 1 is essential for the functioning of the passenger protection device according to the present invention. FIG. 2 shows an example implementation. Here, flow-off valve 10 is formed in the housing wall of a housing part 20 that acts as a connecting module 6. Airbag 1 is connected to housing part 20 via an opening, situated opposite flow-off valve 10, in the housing wall. FIG. 2 shows airbag 1 in the compressed (folded) state.

As gas generator 2, a pressure vessel 21 is used that is filled with a suitable noble gas mixture. The noble gas mixture maybe, for example, a mixture of 94% argon and 6% helium under a pressure of approximately 500 bar, or can also be an argon-nitrogen mixture. Gas generator 2 is likewise connected to housing part 20, so that the seal of pressure vessel 21, formed by a burst disk 22, is situated over another opening in the housing wall. Burst disk 22 can be destroyed with the aid of a correspondingly dimensioned pyrotechnic charge 23 situated on the housing wall, opposite gas generator 2. The gas under pressure then flows out of pressure vessel 21 through housing part 20, on the one hand into connected airbag 1, and can on the other hand flow outward via flow-off valve 10, if this valve is open.

Here the measurement of the deployment speed of airbag 1, or, more precisely, the speed of movement of the upper side of the airbag facing the passenger, takes place optically. For this purpose, in the interior of housing part 20 there is situated a transceiver device 24 with which optical signals, for example pulsed infrared light, are sent into the deploying airbag 1. These signals are reflected by the inside of airbag 1, which has for this purpose a light-reflecting coating 25 on at least some parts. Because the noble gas mixture in the airbag 1 is very clean, optical signals can propagate here in unhindered fashion. From the change of the “time of flight” of the reflected pulsed infrared light, the speed of movement of the airbag upper side facing the passenger can be calculated. Of course, the deployment speed can also be determined using other optical measurement methods, in which, for example, the Doppler effect or a triangulation method is used.

If the deployment speed decreases before the airbag has been completely inflated, this indicates the presence of an obstacle in the deployment path of the airbag. This may indicate an out-of-position passenger situation. In order to prevent the passenger from being injured by the deploying airbag, a part of the filling gas flowing out of gas generator 2 can be diverted outward with the aid of flow-off valve 10, as indicated by arrows 26. Nonetheless, airbag 1 should cushion an impact of the passenger as well as possible. Therefore, the quantity of the filling gas diverted outward is regulated in such a way that the overall risk of injury to the passenger is minimized as much as possible.

As already mentioned, FIG. 3 shows a top view of the seal of flow-off valve 10 shown in FIG. 2, corresponding to a top view of the sectional plane designated AA. Here, flow-off valve 10 is realized in the form of a sealing panel in the wall of connecting part 20, having an essentially quadratic opening 13, and having a sealing part 14 that is dimensioned corresponding to opening 13 and is held in opening 13 with the aid of actuating means 15, or, given a corresponding controlling of actuating means 15, can be lifted more or less away from opening 13.

In the exemplary embodiment described here, opening 13 has a surface of approximately 0.5 cm×0.5 cm=2.5 cm². Because the gas generator contains an excess quantity of filling gas, the seal of flow-off valve 10 should not be tight. Generally, the throttle effect for the gas pressing outward is still sufficient if a narrow slit, approximately 0.1 mm in width, remains when the valve is closed. Given a valve stroke of approximately 1 mm, a free surface of 0.25 cm² results, with a slit width of 0.5 mm, if the wall thickness of connecting part 20 is 0.5 mm at the valve point. For a gas pressure of 200 bar, a force of 0.5 kN, which must counteract actuating means 15, acts on the sealing panel. If an airbag inflation time of 30 ms is assumed, a complete valve stroke should not last longer than 0.5 ms in order to be able to quickly regulate the movement speed of the front side of the airbag. This requirement could be met, for example, by a correspondingly dimensioned fast electromagnet that directly actuates sealing part 14.

Actuating means 15 may also include a piezoactuator 17 designed for the deployment of a high degree of force. Piezoactuator 17, shown in FIG. 4, is realized in the form of a 50 mm high piezo stack that undergoes an expansion of 0.125 mm at a drive voltage of 300V. In order to achieve with this a stroke of 1 mm of sealing part 14, a stroke multiplication is required, which can be realized, for example, with the aid of a mechanical lever 18 having eightfold multiplication, as shown in FIG. 4. Here, lever 18 presses on the piezo stack with a force of 0.4 tons, which this stack can withstand in the compression direction, but not in the tensile direction or shear direction. Therefore, piezoactuator 17 must be operated in such a way that the flow-off valve is opened when the piezo stack expands.

1-7. (canceled)

8. A protection device for a passenger in a vehicle, comprising:
an airbag;
a gas generator for filling the airbag;
an airbag control device for activating the airbag;
a measurement unit for acquiring a deployment speed of the airbag;
a connecting module for regulating a filling quantity of the airbag, taking into account the deployment speed of the airbag, wherein the connecting module includes a flow-off valve situated between the gas generator and the airbag; and
a controlled actuating unit for selectively sealing the flow-off valve.

9. The protection device as recited in claim 8, wherein the controlled actuating unit for selectively sealing the flow-off valve is controlled by the airbag control device.

10. The protection device as recited in claim 8, wherein the controlled actuating unit for selectively sealing the flow-off valve includes at least one piezo-actuator connected to one of a mechanical lever device and a hydraulic lever device.

11. The protection device as recited in claim 8, wherein the controlled actuating unit for selectively sealing the flow-off valve includes at least one electromagnet.

12. The protection device as recited in claim 8, wherein the gas generator for filling the airbag is a cold-gas generator having a pressure vessel filled with a noble gas mixture under pressure, wherein the pressure vessel is sealed by a burst disk that is configured to be destroyed with the aid of a pyrotechnic charge.

13. The protection device as recited in claim 8, wherein the measurement unit for acquiring the deployment speed of the airbag includes a transceiver device for sending an optical signal into the airbag, and wherein at least a portion of the inside of the airbag is provided with a light-reflecting coating.

14. The protection device as recited in claim 13, wherein the deployment speed of the airbag is determined by one of: a) measuring a propagation time of the optical signal; b) utilizing the Doppler effect with respect to the optical signal; and c) utilizing a triangulation method with respect to the optical signal.
